(19) United States
(12) Patent Application Publication
(10) Pub. No.: US 2019/0133380 A1
(43) Pub. Date: May 9, 2019

(54) Method of Operating a Kitchen Machine, Kitchen Machine as well as Ambience System

(71) Applicant: Vorwerk & Co. Interholding GmbH, Wuppertal (DE)

(72) Inventor: Sabrina Hoffmann, Solingen (DE)

(21) Appl. No.: 16/182,933

(22) Filed: Nov. 7, 2018

(30) Foreign Application Priority Data
Nov. 8, 2017 (DE) 10 2017 126 107.9

(51) Int. Cl. A47J 44/00; H04L 29/08; H04L 12/28

(52) U.S. Cl. CPC A47J 44/00; G06F 3/0482; H04L 12/2816; H04L 67/306

(57) ABSTRACT

The invention relates to a method (100) of operating a kitchen machine (1) suitable for preparing foods,
including the following steps:
   specifying (104) a recipe (11) for preparing the foods,
   determining (106) a thematic category (20) assigned to the recipe (11).

Furthermore, the invention relates to a kitchen machine (1) for preparing foods, as well as an ambience system (40).

### DESCRIPTION

The invention relates to a method of operating a kitchen machine, a kitchen machine for the preparation of foods, as well as an ambience system.

Kitchen machines, by means of which foods can effectively be prepared, are known from the prior art. These types of kitchen machines are often capable of guiding a user through a recipe, and indicating the different steps for carrying out the recipe one after the other to the user. Furthermore, diverse functions are often integrated in these types of kitchen machines, to heat dishes, stir ingredients or even steam cook. One major advantage of such a kitchen machine is that many functions, which are required for the preparation of meals are integrated in one single device.

Such functions have thus far been limited, however, essentially to the direct cooking context to facilitate the cooking process for the user. However, cooking is often connected with emotions and/or undergoes, in different situations, a different prioritization by the user. In this way, the user may want to experience an emotional cooking evening in some situations, in other situations the user may want to get himself into the mood for an event, and in yet other situations, the user may want to get to the cooking results as effectively as possible. Kitchen machines known from the prior art can thus far, however, only have little influence on the respective situation or surroundings of the user during the cooking.

It is thus the object of the present invention to at least partially resolve the disadvantages known from the prior art. It is in particular an object of the present invention to improve the situational impression of the user while preparing foods, and/or to improve a cooking experience with a fitting ambience.

The object of the invention is achieved by a method of operating a kitchen machine with the features of the independent claim 1, a kitchen machine with the features of the independent claim 9, as well as by an ambience system with the features of the independent claim 15.

Further features and details of the invention result from the dependent claims, the description and the drawings. Features and details described in conjunction with the method according to the invention also apply in conjunction with the kitchen machine according to the invention and/or the ambience system according to the invention, and vice versa, so that with regard to the disclosure, reference is or can always mutually be made to the individual aspects of the invention.

According to the invention, a method of operating a kitchen machine, suitable for preparing foods, comprising the following steps:
Specifying a recipe for the preparation of the foods,
determining a thematic category, which is assigned to the recipe,
providing an entertainment medium depending upon the thematic category.

Preferably, the kitchen machine is a kitchen machine which is suitable for the semiautomatic or fully-automatic preparation of the foods. To that end, the kitchen machine can comprise a control unit for working through the recipe, for example. Furthermore, the kitchen machine can comprise a stirring unit, a means for heating the foods and/or further functions for the performing of the cooking process. Thus, the user can preferably first specify the recipe for preparing the foods, wherein the recipe is assigned to at least one thematic category. The determination of the thematic category can be effected directly or indirectly from the recipe. Thus, the recipe can be linked with tags for example, which directly represent the thematic category. However, it is likewise conceivable that the thematic category is determined from different tags of the recipe and/or from further user input. This can be effected by means of a controller of the kitchen machine, and/or by means of an external server, to which the kitchen machine can be connected. In particular, the thematic category can be determined automatically, or at least party automatically, wherein e.g. the thematic category is selected in accordance with the weekday and/or the calendar of the user. In particular, a user configuration to that end can be stored in advance. Furthermore, it is also possible that first the thematic category is determined, e.g. by the selection of the user. Thereupon, the recipe that is assigned to the thematic category, or which is assigned the thematic category, can be specified from the thematic category in a random fashion, or based upon further factors. Preferably, the thematic category and the recipe are linked to one another in advance, directly or indirectly.

Preferably, the thematic category further includes at least one of the following categorizations:
region-based (e.g. regional, Italian, Greek),
experience-driven (e.g. thriller dinner, story, musical)
emotion-driven (e.g. musical style, related to excitement)
user-specific (e.g. preferences, hobbies)
teaching (e.g. tutorials, detailed instructions for the performing of the recipe steps).

An entertainment medium in the context of the present invention can be understood as a sound compilation, for example, i.e. e.g. a musical piece or a selection of background noises (e.g. sound of the ocean, a fitting narration, or a sequence of verbal instructions). Furthermore, the entertainment medium in particular can be understood as a video, or a video clip, which can be displayed on a display device of the kitchen machine, for example. The dependency of the entertainment medium can be effected dependent upon existing lists, where e.g. different entertainment media (such as music titles) can be assigned to a thematic category. In particular, the provided entertainment medium can be selected from multiple entertainment media in a random manner, which correspond to the thematic category. Furthermore, it is conceivable that the entertainment medium is determined automatically from the thematic category, preferably based upon a sequence of sounds of a sound compilation. Thus, it is conceivable that the thematic category is e.g. “emotion-oriented”, and slow musical pieces are provided as a result. Preferably, the entertainment medium can be provided in a digital or analog form, wherein the entertainment medium is provided e.g. on a CD, as a file of a storage unit of the kitchen machine, or via streaming access. The speed of the cooking process can be increased by video tutorials, for example, and thus the feeling of the user with respects to the cooking process can be improved, in particular if the user is in a hurry.

Thus, an ambience suitable to the respective recipe can be created by the method according to the invention. The ambience can already be created when preparing the foods, e.g. to create a pleasant anticipation of the food, and/or the ambience can be improved by the entertainment medium during the subsequent meal.

Furthermore, it is conceivable in a method according to the invention that the method includes the following step:
determining a recipe type of the recipe, via which the thematic category is assigned to the recipe, in particular wherein the recipe data are provided by the kitchen machine.

Thus, the selection of the recipe can for example be effected via a display device of the kitchen machine and the recipe type can result automatically, in particular based upon tags linked with the recipe. Furthermore, it is conceivable that the selection of the recipe occurs in a random manner from the recipe collection, dependent upon the type of recipe. In this case, the user may select only the recipe type in advance, for example, whereupon the recipe is specified dependent upon the recipe type. A recipe collection can comprise a list of multiple recipes in a database, for example. The recipe data can advantageously include a composition of the foods, a guide for carrying out the cooking steps, or the like. Preferably, at least some recipe data can be provided by the kitchen machine per se. Furthermore, the recipe type can be directly or indirectly linked with the thematic category, wherein e.g. the recipe type can be determined from the thematic category, or the thematic category can be determined from the recipe type, for example. Thus, it is conceivable that the recipe type includes the keyword “Italian”, while the thematic category may include the keyword “Mediterranean” in an abstracted form, so that different thematic categories can fit certain types of recipes. In particular, however, the thematic category and the recipe type can at least partially or completely match. Through the recipe type, the provision of an additional intermediate level for the selection of the entertainment medium, which can permit further assignments within a data structure, is possible. As a result, an improved selection of the entertainment medium can be made possible in regard to the respective situation.

Preferably, in a method according to the invention, the specifying of the recipe can be carried out by selecting the recipe from a recipe collection by a user, or automatically. The recipe collection can, as described above, include a list of a database, wherein meta data and/or actual data of the recipes can be provided in the database. It is thus conceivable that merely the metadata, such as the name and/or keywords of the recipes, are stored, and the actual cooking steps of the recipe are made available only after the selection, e.g. by downloading from the internet. In the automatic selection of the recipe, the recipe type can be determined by the user, for example, and/or the selection can be effected based upon further user input, e.g. information on existing ingredients. By specifying the recipe and the recipe collection, a selection of the entertainment medium, or the assignment of the thematic category, can be facilitated, so that a suitable entertainment medium can be selected in a more targeted manner.

Advantageously, a method according to the invention may further comprise the following steps:
access to an external database
providing an external entertainment media collection by the external database,

in particular wherein the provision of the entertainment medium occurs through the external entertainment media collection. The access, in particular of the kitchen machine, to the external database, can be effected in a wireless manner, i.e. e.g. optically, via Bluetooth, or WLAN, or in a cable-bound manner. The external database can preferably include a USB storage device, an internet streaming service, a cloud and/or the like. In particular, the external database can be provided on an external server. The external entertainment media collection preferably includes a database of a streaming service, a directory and/or a folder structure of files on a USB memory device or the like. The selection of the entertainment medium can be extended by the external database, in particular independently from the kitchen machine. It is thus conceivable that the user receives access to the entertainment media collection via a subscription service, and/or can upgrade the media collection by additional purchases. Furthermore, it is not necessary, due to the external entertainment media collection, that the entertainment media are provided directly on the kitchen machine, so that a storage unit of the kitchen machine can have a smaller size.

In addition, it is conceivable that the method comprises the following step in a method according to the invention:
providing of an internal entertainment media collection by the kitchen machine,

in particular, wherein the provision of the entertainment medium occurs through the internal entertainment media collection. The internal entertainment media collection can advantageously be provided directly with the acquisition of the kitchen machine, so that for e.g. at least some music tracks are already present on the kitchen machine. In particular, the selection of the entertainment medium can be effected out of the internal and/or external entertainment media collection. Thus, it is conceivable that some entertainment media are provided through the internal entertainment media collection, and some entertainment media are provided through the external entertainment media collection, so that a broader selection from the internal and external entertainment media collection in combination is possible. It is of advantage in a purely internal entertainment collection that the kitchen machine is not connected to an external database, and thus an internet connection, or an interface with the external database at all is not necessary. Moreover, the internal entertainment media collection can be matched to internal, provided recipes, so that the access to an external database is not necessary. Preferably, the internal and/or the external entertainment media collection can be assigned to a thematic category, in particular so that the assignment of the entertainment medium to be provided results from the assignment of the entertainment media collection to the thematic category.

In the scope of the invention, the method can further include the following step:
playing the entertainment medium,

in particular wherein the playing of the entertainment medium is carried out by the kitchen machine and/or by an activation of at least one external playing device. If the external playing device is activated, the external playing device can, e.g. receive a signal from the external database and/or from the kitchen machine, which signal activates the external playing device. In particular, multiple external playing devices can be activated. It is thus conceivable that the external playing device is only indirectly connected to the kitchen machine and is completely activated by an external server. Additionally or alternatively, the kitchen machine can also comprise an internal playing device . A playing device in the context of the present invention can preferably include a loudspeaker and/or a display device, via which the entertainment medium is presentable to the user. An internal playing device can comprise, e.g., a display of the kitchen machine and/or a loudspeaker of the kitchen machine. An external playing device can include a mobile telephone, a HiFi system, a television and/or the like. Through the integration of the playing into the method, it is possible that the entertainment medium can be played directly for the user. As a result, the cooking experience can be further automated and the comfort of the user can be improved.

Moreover, the method according to the invention can include the following steps:
compiling a profile collection from different entertainment media,
storing the profile collection,

in particular, wherein the profile collection is automatically compiled based upon a history of the user or by a selection of the user. The profile collection can include a database, which stores the different entertainment media, or at least comprises metadata for the entertainment media. It is thus conceivable that indications to the entertainment media are present in the database so that these entertainment media can be called up via the references, particularly individually, to be played. At least one or multiple method steps can be repeated on the basis of the profile collection. It is thus conceivable that within the profile collection, multiple entertainment media are provided successively, for example, wherein the profile collection per se can be assigned to a thematic category, or the entertainment media with the profile collection can be selected in dependence upon the thematic category. Under the user history, a user behavior can be understood, in particular which behavior repeats itself. It is thus conceivable that the profile collection is created out of the selections of recipes and/or entertainment media made in the past. The profile collection can in particular be extendable. The cooking experiences can thus be personalized, wherein it can be ensured, through the profile collection, that the entertainment medium provided pleases the user. The profile collection can in particular be assigned to a user profile, and the method can include the following step:
selection of a user profile, to which the profile collection is assigned.

Multiple users of the kitchen machine can thus, for example, create individual profile collections, and/or multiple user profiles with multiple profile collections can be created on a server.

In a method according to the invention, the method can preferably further include the following step:
sending the profile collection via a transmission interface.

The transmission interface can advantageously be configured to transmit the profile data to a mobile telephone and/or a server. As a result, it is conceivable e.g. that a user can share their profile collection with other users, so that the other users can also have access to the already previously created profile collection.

According to a further aspect of the invention, a kitchen machine for preparing foods is claimed. The kitchen machine comprises a user interface, by means of which a user input for specifing a recipe is made possible. Moreover, the kitchen machine comprises a control unit which is configured to determine a thematic category assigned to the recipe, wherein the control unit can be brought into a communication connection with a storage unit, so that an entertainment medium can be provided dependent upon the thematic category. The control unit can advantageously include a microprocessor, a CPU and/or an integrated circuit. The entertainment medium is in particular stored in the storage unit so that the entertainment medium can be called up.

A kitchen machine according to the invention thus brings with it the same advantages as have already been described in detail with respect to a method according to the invention. The specifying of the recipe by the user can be advantageously carried out through a direct specifying of the recipe, e.g. through selection via a touchscreen, or an indirect specifying of the recipe via a selection of a recipe type via the user input. The storage unit can preferably include an entertainment media collection. The storage unit can thus comprise a database in which metadata or actual data of different entertainment media are stored. The user interface can preferably be configured optically, mechanically, and/or acoustically. It is thus conceivable that the user interface includes one or multiple operating buttons on the kitchen machine, a gesture recognition, a speech recognition or the like. The communication connection of the control unit with the storage unit can e.g. be provided through a wiring inside the kitchen machine, if the storage unit is an internal storage unit of the kitchen machine. The control unit can accordingly constantly be in communication connection the first storage unit. Moreover, it is conceivable, however, that the kitchen machine can be wirelessly or in a cable-bound manner be brought into communication connection with an external storage unit. To that end, a transmission interface for communication with the control unit and/or the storage unit can preferably be provided, in particular wherein the communication connection is e.g. a LAN, WLAN, Bluetooth, or USB connection.

Within the scope of the invention, it is conceivable that the user interface includes a display, in particular wherein a recipe type and/or the recipe can be displayed to the user by the display. As a result, a visual communication can be made possible with the user, for example, wherein the recipe and/or the recipe type can be selectable via the user interface. The user interface can preferably be a touchscreen, which makes possible a comfortable input possibility for the user. A simple, intuitive operation of the kitchen machine can thus be achieved through the user interface, and an abundance of information can simultaneously be made available for the user. The cooking experience as a whole can further be improved as a result.

In a kitchen machine according to the invention, it is moreover conceivable that the control unit is configured allow the user to make a creation of a profile collection via the user interface, wherein the profile collection can be stored in the storage unit or in a further storage unit. The further storage unit can preferably be an internal or an external storage. It is conceivable that a first, internal storage unit is provided in the kitchen machine, and the kitchen machine can be connected to a second, external storage unit. The profile collection can moreover be storable internally and/or externally. In particular, a synchronization can be provided between the first and second storage units, which synchronization matches the data of both storage units. The cooking experience can further be personalized and thus improved as a whole for the user through the profile collection.

It is moreover conceivable that, in a kitchen machine according to the invention, the storage unit comprises an external database and/or an internal storage of the kitchen machine with an internal database. In particular, the external and the internal database can thus form a common database in order to provide the entertainment medium. As a result, the selection of different entertainment media can be increased, while the internal storage can be limited, the external database on a server can, however, be extended at any time. As a result, the selection of the entertainment media which are available can be adaptable, and thusly, the entertainment medium can be selected and provided from current entertainment media.

It is moreover conceivable in a kitchen machine according to the invention, that the control unit is configured to activate an external playing device in such a manner that the entertainment medium can be played by the external playing device. To that end, the control unit, e.g. via a transmission interface of the kitchen machine, can be in communication connection directly with the external playing device, or indirectly via a server. As a result, e.g. a HiFi system can be activatable in the household of the kitchen machine so that a user can enjoy a high sound quality of the HiFi system, while the installation space of the kitchen machine can be minimized and the kitchen machine only requires a small space requirement in the user's kitchen.

It is moreover conceivable within the scope of the invention that an internal playing device is provided which can be activated by the control unit, in such a way that the entertainment medium can be played. The internal playing device can preferably include a loudspeaker on the kitchen machine. An external playing device is thus not necessary, and the user can get the benefit of the entertainment medium via the internal playing device with the purchase of the kitchen machine. Furthermore, the internal playing device can be particularly advantageously tuned to the machine in its compatibility. The improved cooking experience can thus be provided to the user in a simple manner.

In a kitchen machine according to the invention, the control unit can preferably be configured to initiate, in particular carry out, a method according to the invention. Under the initiating of the method, it can be understood to that end that at least a partial working through of the method steps, e.g. by an external server, is triggered by a signal of the kitchen machine. Thus, for example, the selection of the recipe by the user can be sent to the server, which server, based upon the data provided, chooses the entertainment medium. Preferably, control unit is, however, configured to carry out the method in particular inside the kitchen machine. To that end, a corresponding computing capacity can advantageously be made available through the control unit.

According to a further aspect of the invention, an ambience system with a server for providing an external entertainment media collection and a kitchen machine according to the invention is claimed. The kitchen machine here can be brought in communication connection with the server, in particular for access to an external database of the server. Preferably, the kitchen machine comprises a transmission interface to that end, via which the communication connection between the kitchen machine and the external database can be realized. In particular, it can be provided that an external playing device for playing the entertainment medium out of the external and/or an internal entertainment media collection is provided. Here, the player can be in communication connection, or can be brought into communication connection with the kitchen machine or the external database, so that the entertainment medium is, in particular, automatically playable. An ambience system according to the invention thus comes with the same advantages as have already been described in detail with respect to a kitchen machine according to the invention and/or a method according to the invention.

Further measures improving the invention result from the following description of several exemplary embodiments of the invention, which are schematically illustrated in the figures. All features and/or advantages resulting from the claims, the description or the illustrations, including constructive details, spatial arrangements, and method steps, can be essential to the invention in and of themselves, as well as also in the most various combinations. Here, it should be noted that the figures are only of a descriptive character, and are not intended to limit the invention in any form. Shown are in:

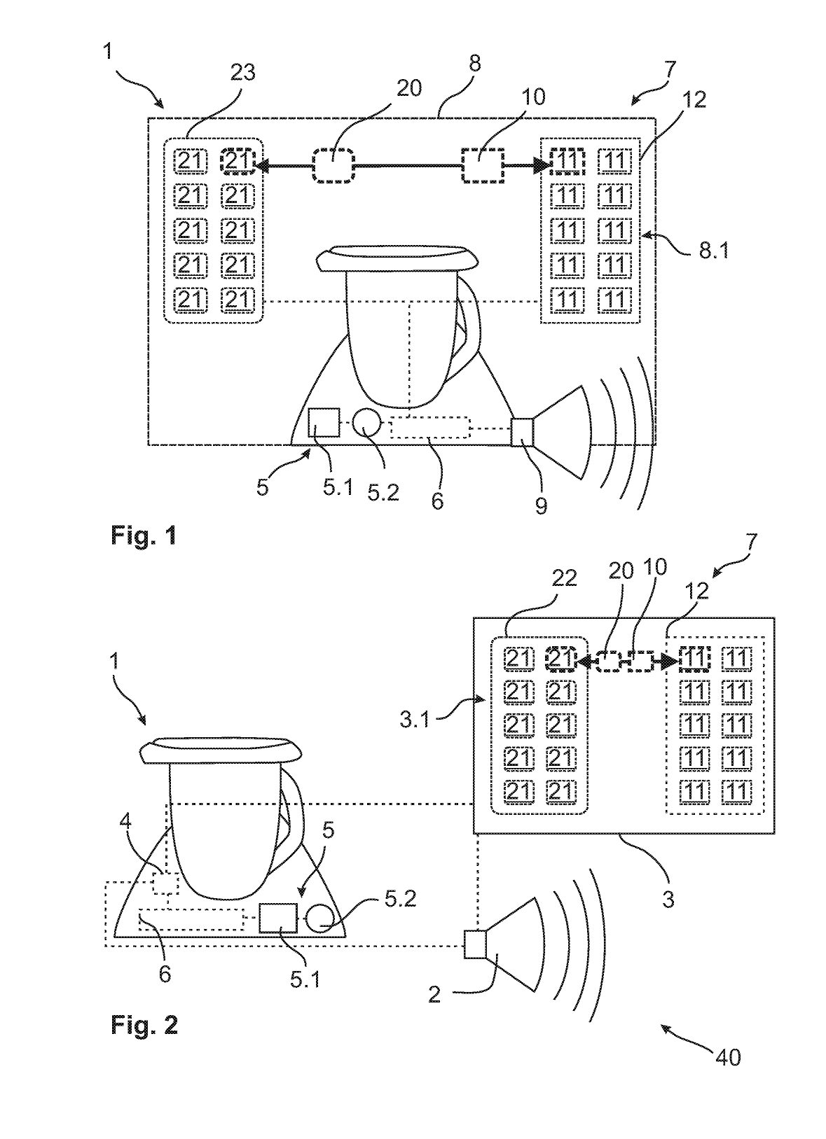

FIG. 1 a kitchen machine according to the invention in a schematic illustration in a first exemplary embodiment,

FIG. 2 a kitchen machine according to the invention in an ambience system according to the invention in a further exemplary embodiment,

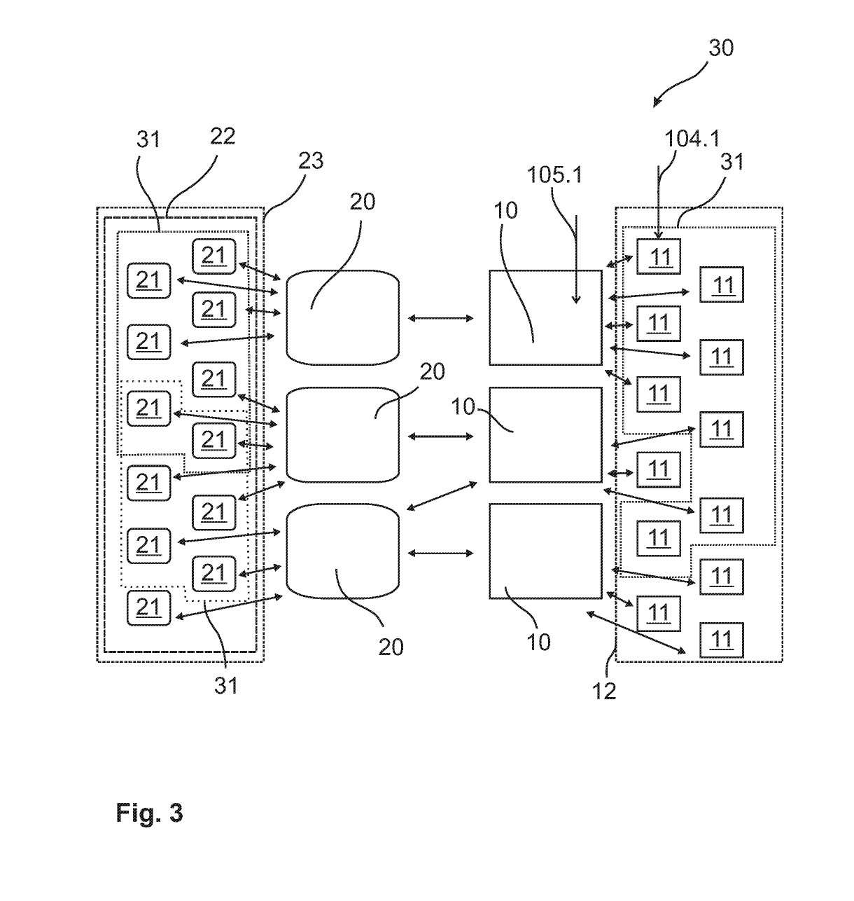

FIG. 3 a data structure for providing an entertainment medium for a method according to the invention and/or a kitchen machine according to the invention in a further exemplary embodiment,

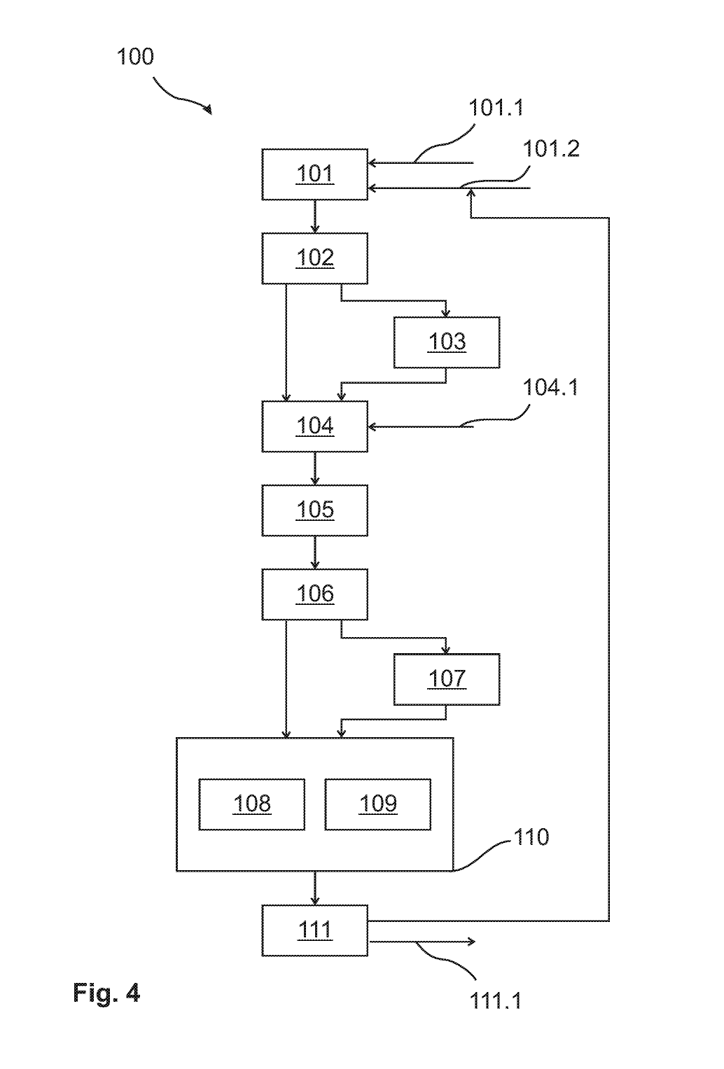

FIG. 4 a schematic illustration of method steps of a method according to the invention in a further exemplary embodiment,

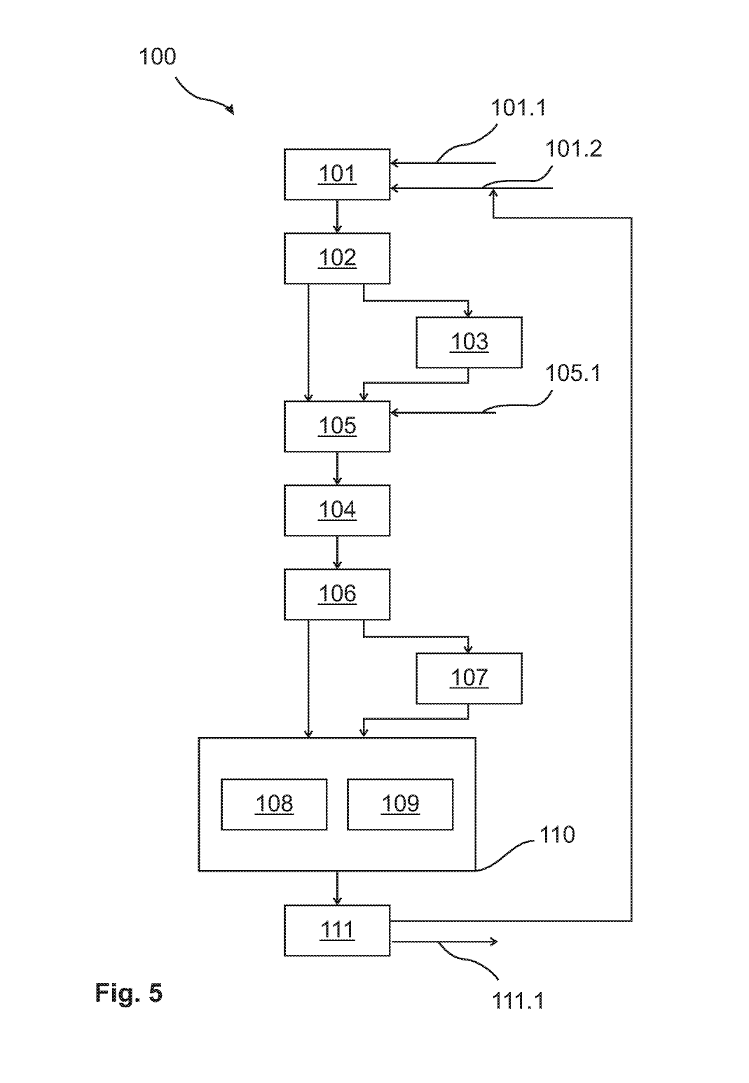

FIG. 5 a schematic illustration of method steps of a method according to the invention in a further exemplary embodiment.

In the following figures, the identical reference characters are used for the same technical features, even from different exemplary embodiments.

FIG. 1 shows a kitchen machine 1 according to the invention for the preparation of foods in a first, schematically-illustrated exemplary embodiment. The kitchen machine 1 here comprises a user interface 5, which includes a display 5.1, as well as an input means 5.2 in the form of a rotary knob. The display 5.1 is preferably configured as a touchscreen so that the user can also perform a selection via the display 5.1. The user interface 5 is moreover connected with a control unit 6 of the kitchen machine 1. Via the user interface 5, in particular a recipe 11 is selectable from a recipe collection 12, wherein the recipe 11 serves as a guide for the preparation of foods. Via the control unit 6, a thematic category 20 can here be determined, which thematic category is assigned to the recipe 11. If the user selects e.g. a noodle recipe, in which Italian herbs are used, a recipe type 10 can be determined from the recipe 11 through the control unit 6, which recipe type is “Italian”. A thematic category 20, assigned to the recipe 11 via the recipe type 10 can accordingly likewise include the keyword “Italian” and/or “Mediterranean”. If the thematic category 20 is determined, a storage unit 7 can be accessed by the control unit 6, which storage unit comprises an internal storage 8 with an internal database 8.1. The internal database 8.1 can preferably include an internal entertainment media collection 23, from which an entertainment medium 21 can be selected via the control unit 6. In the above-mentioned example, the selected entertainment medium 21 is Italian music in particular. This can ultimately be played via an internal playing device 9 and/or an external playing device 2. As a result, an ambience can already be generated during the cooking process with the kitchen machine 1 and/or after the cooking process with the kitchen machine 1, which ambience matches the selected recipe 11, and thus improves the cooking experience, with the kitchen machine 1 for the user. For the sequence of the recipe 11, the kitchen machine 1 can preferably include a stirring unit, as well as at least one heating means (not illustrated), and can specify to the user the individual steps of the recipe 11 to be carried out via the display 5.1.

FIG. 2 shows an ambience system 40 according to the invention with a kitchen machine 1 and a server 3, which server includes and external database 3.1. At least one recipe collection 12 with recipes 11, as well as entertainment media 21 are stored in the external database 3.1. The entertainment media 21 here is assigned a thematic category 20, and the recipes 11 are assigned a current recipe type 10. Preferably, recipe types 10 and thematic categories 20 are, in turn, likewise assigned to one another. Via a user interface 5, a user can, via the kitchen machine 1, at least indirectly access the external database 3.1. To that end, the user interface 5 is connected with a control unit 6 of the kitchen machine 1, which is connected with a transmission interface 4. Via the transmission interface 4, the kitchen machine 1 is moreover in communication connection with the server 3, so that the external database 3.1 can be accessed. Different recipes 11 can thus be displayed to the user for selection, e.g. on a display 5.1 of the user interface 5, wherein the user selects a recipe 11 or a recipe type 10, and the control unit 6, based upon the recipe 11, determines a recipe type 10, or corresponding to the recipe type 10, selects a recipe 11. An entertainment medium 21 is correspondingly selected, in dependence upon the thematic category 20, from an entertainment media collection 22 of the server 3, which entertainment medium 21 can be played on an external playing device 2. The external playing device 2 can e.g. be a HiFi system, a television, or the like. As a result of the fact that the data of the entertainment medium 21 are provided on the server 3, it is not necessary to provide an internal storage unit of the kitchen machine 1 having the entertainment media 21, so that a storage capacity of the server 3 can be used, which server is simpler to maintain and to extend than a possible internal storage of the kitchen machine 1. In particular, the server 3 can directly communicate with the external playing device 2, or the communication can be effected via the kitchen machine 1, in particular the control unit 6 of the kitchen machine 1. An ambience can thus be created for a user, which ambience fits the selected recipe 11, and ultimately improves the cooking experience and/or the ambience of the subsequent meal.

FIG. 3 shows a data structure 30 for providing an entertainment medium 21 in a further exemplary embodiment. In particular, the data structure 30 can be provided inside a database, which database can include an internal database 8.1 or an external database 3.1. Here, recipes 11 are provided inside the data structure 30, which recipes are respectively assigned to a recipe type 10. If the user now selects the recipe type 10 and/or the recipe 11, the recipe type 10 and/or the recipe 11 can reciprocally, e.g. by means of a control unit 6, be concluded. The recipes 11 are preferably part of a profile collection 31, wherein the profile collection 31 can be linked, e.g. with a user account, so that the fact which recipes 11 a user is in favor of, is assigned inside the data structure 30. Via the recipe type 10, a thematic category 20 is indirectly assigned to a recipe 11, wherein the thematic category 20, in turn, is assigned different entertainment media 21. A profile collection 31 can preferably be provided also for the entertainment media 21, or multiple profile collections 31. Here, the profile collections 31 can also coincide with one another, and/or at least one profile collection 31 can be assigned to every user. Moreover, the entertainment media 21 can originate from an external entertainment media collection 22 and/or an internal entertainment media collection 23. The external entertainment media collection 22 can e.g. include entertainment media 21, which are retrievable from a server 3, and the internal entertainment media collection 23 can preferably comprise such entertainment media 21 as are contained in an internal database 8.1 of an internal storage 8 of the kitchen machine 1. Preferably, the internal and the external entertainment media collections 22, 23 can by synchronized, in particular so that both contain at least partly identical data. Thus, at least one at least indirect assignment of an entertainment medium 21 is present between each recipe 11, wherein the actual selection of the entertainment medium 21, based on the recipe 11, can be determined by many further factors, such as e.g. a history 101.2 about the behavior of the user, or the like.

FIG. 4 shows method steps of a method 100 according to the invention for operating a kitchen machine 1, which is suitable for the preparation of food, in a schematic view, in a further exemplary embodiment. A compiling 101 of a profile collection 31 is provided here in the scope of the method 100. The profile collection 31 can preferably include recipes 11 and/or entertainment media 21 which a user is in favor of. To that end, a pre-selection 101.1 can occur through the user, or the profile collection 31 can be automatically compiled based upon a history 101.2 of a user. If the steps of the method 100 are frequently repeated, the profile collection 31 can be adapted in a self-learning manner, and the cooking experience can, as a result, be further adapted to the user, and can thus be personalized. A storing 102 of the profile collection 31 can here be carried out onto a server 3 in an external database 3.1 and/or in an internal database 8.1 of an internal storage 8, so that the profile collection 31 is permanently available for the user in the switching-on of the kitchen machine 1. If the profile collection 31 is provided on a server 3, a sending 103 of the profile collection 31 via a transmission interface 4 of the kitchen machine 1 can moreover be effected. As a result, the user can share their own profile collection 31, for example with other users, so that these users can likewise benefit from the compiling 101. Preferably, the specifying 104 of a recipe 11 is thereupon effected. This can be effected e.g. through a user at a user interface 5. This way, different recipes 11 can be advantageously offered to a user via a display 5.1, so that the user only decides upon one of the recipes 11, and performs a corresponding manual selection 104.1. On the basis of the specifying 104, a determining 106 of a thematic category 20 is thereupon carried out, which thematic category is assigned to the recipe 11. To that end, preferably a specifying 105 of a recipe type 10 can be performed, which recipe type in particular corresponds to the thematic category 20. Thereafter, a new accessing 107 of the kitchen machine 1 to the external database 3.1 can be effected, if entertainment media 21 are provided on the external database 3.1. After a determining 106 of the thematic category 20 or of the accessing 107 of the kitchen machine 1 to the external database 3.1, a provision 110 of the entertainment medium 21 can be effected, depending on the thematic category 20. Here, the provision 110 of the entertainment medium 21 can include a provision 108 of an external entertainment media collection 22 and/or a provision 109 of an internal entertainment media collection 23, wherein an entertainment medium 21 is selected from the internal and/or external media collection 22, 23. Subsequently, a playing 111 of the entertainment medium 21 is effected, preferably an activating 111.1 of at least one external and/or internal playing device 2, 9. By this, the user benefits from the entertainment medium 21, so that the overall cooking experience can be improved.

FIG. 5, in a schematic illustration, shows method steps of a method 100 according to the invention in a further exemplary embodiment. Here, the exemplary embodiment of FIG. 5 essentially corresponds the exemplary embodiment of FIG. 4, wherein, however, a specifying 104 of a recipe 11 for preparing foods occurs after a determination 105 of a recipe 10. In this case, a selecting 105.1 of a recipe type 10 is performed by the user, or automatically, and, by means of further criteria, such as for example a history 101.2 of a user behavior, a recipe 11 that matches a recipe type 10 is selected. Thereafter, as described in the previous embodiment, a specifying 106 of a thematic category 20 is effected, which is assigned to the recipe 11 in particular through the recipe type 11.

The above explanation of the embodiments describes the present invention exclusively by means of examples. It goes without saying that individual features of the embodiments, insofar technically reasonable, can freely be combined, without departing from the scope of the present invention.

### LIST OF REFERENCE CHARACTERS

1 Kitchen machine

2 External player device

3 Server

3.1 External database

4 Transmission interface

5 User interface

5.1 Display

5.2 Input means

6 Control unit

7 Storage unit

8 Internal Memory

8.1 Internal database

9 Internal player device

10 Current recipe type

11 Recipe

12 Recipe collection

20 Thematical category

21 Entertainment medium

22 External entertainment media collection

23 Internal entertainment media collection

30 Data structure

31 Profile collection

40 Ambience system

100 Method

101 Compiling of 31

101.1 Selection by 30

101.2 History

102 Storing of 31

103 Sending of 31

104 Specifying of 11

104.1 Manual selection of 11

105 Determination of 10

105.1 Manual selection of 10

106 Determination of 20

107 Access to 3.1

108 Provision of 22

109 Provision of 23

110 Provision of 21

111 Playing of 21

111.1 Controlling of 2

1. Method of operating a kitchen machine suitable for preparing foods, comprising the following steps:
specifying a recipe for the preparation of the foods,
determining a thematic category, which is assigned to the recipe,
providing an entertainment medium dependent upon the thematic category.

2. Method according to claim 1,
wherein the method further includes the following step:
determining a recipe type of the recipe, via which the thematic category is assigned to the recipe.

3. Method according to claim 1,
wherein the specifying of the recipe is carried out by selecting the recipe from a recipe collection by a user, or automatically.

4. Method according to claim 1,
wherein the method further comprises the following steps:
access to an external database,
providing an external entertainment media collection by the external database.

5. Method according to claim 1,
wherein the method further comprises the following step:
providing an internal entertainment media collection by the kitchen machine.

6. Method according to claim 1,
wherein the method further comprises the following step:
playing the entertainment medium.

7. Method according to claim 1,
wherein the method further comprises the following steps:
compiling a profile collection from different entertainment media,
storing the profile collection.

8. Method according to claim 1,
wherein the method further includes the following steps:
sending the profile collection via a transmission interface.

9. Kitchen machine for preparing foods, comprising
a user interface, by means of which a user input for specifying recipes is made possible, and
a control unit, which is configured to determine a thematic category assigned to the recipe, wherein the control unit can be brought into a communication connection with a storage unit, so that an entertainment medium can be provided dependent upon the thematic category.

10. Kitchen machine according to claim 9,
wherein the user interface includes a display.

11. Kitchen machine according to claim 9,
wherein the control unit is configured to allow the user to create a profile collection via the user interface, wherein the profile collection can be stored in the storage unit or in a further storage unit.

12. Kitchen machine according to claim 9,
wherein the storage unit comprises at least an external database or an internal storage of the kitchen machine with an internal database.

13. Kitchen machine according to claim 9,
wherein at least the control unit is configured to activate an external playing device in such a way that the entertainment medium can be played by the external playing device, or that an internal playing device is provided, which can be actuated by the control unit in such a way that the entertainment medium can be played.

14. Kitchen machine according to claim 9,
wherein the control unit is configured to initiate, a method of operating a kitchen machine suitable for preparing foods, comprising the following steps:
specifying a recipe for the preparation of the foods,
determining a thematic category, which is assigned to the recipe,
providing an entertainment medium dependent upon the thematic category.

15. Ambience system, comprising:
a server for providing an external entertainment medium collection and a kitchen machine for preparing foods, comprising a user interface, by means of which a user input for specifying recipes is made possible, and a control unit, which is configured to determine a thematic category assigned to the recipe, wherein the control unit can be brought into a communication connection with a storage unit, so that an entertainment medium can be provided dependent upon the thematic category,
wherein the kitchen machine can be brought into communication connection with the server.

16. Method according to claim 2,
wherein recipe data are provided by the kitchen machine.

17. Method according to claim 4,
wherein the provision of the entertainment medium occurs through the external entertainment media collection.

18. Method according to claim 5,
wherein the provision of the entertainment medium occurs through the internal entertainment media collection.

19. Method according to claim 6,
wherein the playing of the entertainment medium is carried out at least by the kitchen machine or by an activation of at least one external playing device.

20. Method according to claim 7,
wherein the profile collection automatically compiled based upon a history of the user or by a selection of the user.
